(19) United States
(12) Patent Application Publication
(10) Pub. No.: US 2024/0177142 A1
(43) Pub. Date: May 30, 2024

(54) MOBILE GIFT CERTIFICATE BROKERAGE APPARATUS APPLYING NFT TECHNOLOGY AND METHOD OF USING THE SAME

(71) Applicant: TWOUZ Inc., Daegu (KR)

(72) Inventors: Hanjik RYU, Daegu (KR); Woo-Cheol LEE, Seoul (KR); Myoung-Gyun KANG, Daegu (KR)

(73) Assignee: TWOUZ Inc., Daegu (KR)

(21) Appl. No.: 18/060,157

(22) Filed: Nov. 30, 2022

(30) Foreign Application Priority Data
Nov. 25, 2022 (KR) 10-2022-0160612

(51) Int. Cl. G06Q 20/36; G06Q 20/32; G06Q 20/38

(52) U.S. Cl. CPC G06Q 20/36; G06Q 20/322; G06Q 20/389

(57) ABSTRACT

The present disclosure relates to a mobile gift certificate transaction method applying NFT technology. The method includes NFT-tokenizing a gift certificate code stored in a gift certificate storage unit; receiving a buying signal of a gift certificate from a gift certificate buyer terminal; updating an NFT-tokenized gift certificate code corresponding to the received buying signal; transmitting an access address of the NFT-tokenized gift certificate code corresponding to the received buying signal to a gift certificate receiving terminal; receiving a closure request to close the access address of the gift certificate code from the gift certificate receiving terminal when the gift certificate receiving terminal rejects receiving the gift certificate; and restoring the updated NFT-tokenized gift certificate code, in response to receiving the closure request.

### CROSS-REFERENCE TO RELATED APPLICATIONS

This application claims priority to and the benefit of Korean Patent Application No. 10-2022-0160612 filed in the Korean Intellectual Property Office on Nov. 25, 2022, the entire contents of which are incorporated herein by reference.

### TECHNICAL FIELD

The present invention relates to a mobile gift certificate transaction method applying NFT technology, and more particularly, to a mobile gift certificate brokerage apparatus applying NFT technology and a method of using the same, through which a gift certificate recipient can easily reject receiving a gift certificate transmitted from a gift certificate buyer by enabling the gift certificate recipient to receive an access address of an NFT-tokenized gift certificate code.

### BACKGROUND ART

In general, gift certificates are one of notes issued by merchants, and are one of bearer securities with an undetermined maturity that must be accepted or paid as soon as they are presented. The gift certificates are classified into types of amount indication, goods indication and service indication, for example, depending on receivables indicated on gift certificates. A gift certificate with an amount indication can be redeemed for all goods or services that are handled by an issuer within the limit of an amount of money written on the face of the gift certificate, a gift certificate with a goods indication can be exchanged for goods of a type, a quantity, a standard or a quality indicated on the face of the gift certificate, and a gift certificate with a service indication refers to a gift certificate by which a stated service can be received.

Such a gift certificate is particularly widely used as a gift, and is generally used in a form of buying the gift certificate by paying an amount in advance that can be paid with the corresponding gift certificate, and then giving the gift certificate to another person as a gift. Conventionally, most gift certificates are printed on paper and exchanged as the real thing, and where the gift certificates can be used are limited as compared to cash. However, the gift certificates play the same role as cash for all goods or services that are handled by the issuer.

However, in order to prevent counterfeiting of gift certificates, the manufacturing cost of the gift certificates becomes rather high. Also, there is a problem that there is no way to take back the gift certificate in the form of paper if it is stolen or lost.

In recent years, as mobile terminals such as smart phones and tablet PCs have become widely available, cases in which gift certificates, which have been conventionally printed on paper and used, are produced in a form of mobile gift certificates so that they can be used on the mobile terminals are rapidly increasing.

The mobile gift certificate is also called a gifticon. Gifticon is a compound word of ‘Gift’ and ‘Icon’, which means a gift certificate that can present various gift certificates such as drinks and movie tickets through a mobile terminal. The gifticon is also widely used as a term meaning a mobile gift certificate. The gifticon is given a barcode or unique identification number and is actively distributed online. The mobile gift certificate plays the same role as currency that can be exchanged for real goods. A buyer can pay a certain amount of money online or offline to buy a mobile gift certificate, and give the bought mobile gift certificate to a specific person. The person who received the mobile gift certificate can exchange the mobile gift certificate for real goods or service corresponding to the mobile gift certificate anywhere there is an affiliated store.

Korean Patent Publication No. KR 10-2021-0045616 (Apr. 27, 2021) discloses an invention entitled with ‘a gift certificate reselling transaction brokerage service apparatus for providing safe gift certificate reselling transaction and an operation method thereof’. In this invention, when a first issued gift certificate is registered as a reselling target, the gift certificate is processed to newly issue a next-order reselling transaction gift certificate based on code information of the gift certificate, the previous-order gift certificate is deactivated and an issuance history thereof is saved and managed in a mapping manner so that the previous-order gift certificate remains unavailable until the gift certificate reselling transaction is completed. When the transaction is completed, the next-order reselling transaction gift certificate, not the existing gift certificate, replaces the existing gift certificate. However, when a gift certificate is sold in a reselling manner, a new gift certificate is newly issued based on the code information of the gift certificate, which is cumbersome.

In recent years, when an account number of an individual or a businessman is leaked, voice phishing criminals remit a small amount of money to the account number several times and then report the voice phishing damage to the bank, thereby stopping the account. Therefore, there is a need for an apparatus capable of preventing transfer of cash or transfer of a gift certificate that is unwanted on the recipient side.

### SUMMARY

The present invention has been made in an effort to provide a mobile gift certificate brokerage method applying NFT technology, through which a gift certificate recipient can easily reject receiving a gift certificate transmitted from a gift certificate buyer by enabling the gift certificate recipient to receive an access address of an NFT-tokenized gift certificate code.

The present invention has been also made in an effort to provide a mobile gift certificate brokerage apparatus applying NFT technology, through which it is possible to generate a gift certificate under a new condition by NFT-tokenizing a gift certificate to divide and recombine NFT tokens of different gift certificate codes.

The present invention has been also made in an effort to provide a computer-readable recording medium on which a program for executing the method described above on a computer is recorded.

In order to achieve the first object of the present invention, an exemplary embodiment of the present invention provides a mobile gift certificate transaction method applying NFT technology, the method including: NFT-tokenizing a gift certificate code stored in a gift certificate storage unit; receiving a buying signal of a gift certificate from a gift certificate buyer terminal; updating an NFT-tokenized gift certificate code corresponding to the received buying signal; transmitting an access address of the NFT-tokenized gift certificate code corresponding to the received buying signal to a gift certificate receiving terminal; receiving a closure request to close the access address of the gift certificate code from the gift certificate receiving terminal when the gift certificate receiving terminal rejects receiving the gift certificate; and restoring the updated NFT-tokenized gift certificate code, in response to receiving the closure request.

According to one embodiment of the present invention, when the gift certificate receiving terminal accepts reception of the gift certificate, the gift certificate receiving terminal may connect to the access address and use the gift certificate, and when the gift certificate receiving terminal rejects receiving the gift certificate, a gift certificate buyer of the gift certificate buyer terminal may be registered in a blacklist.

In addition, a gift certificate under a new condition may be generated by dividing and recombining NFT tokens of different gift certificate codes stored in the gift certificate storage unit.

According to another embodiment of the present invention, a future amount of generation of gift certificate balances may be predicted using data of a past amount of generation of gift certificate balances stored in the gift certificate storage unit, and a discount rate of a mobile gift certificate may be presented based on the predicted future amount of generation of gift certificate balances.

In order to achieve the second object described above, an exemplary embodiment of the present invention provides a mobile gift certificate transaction apparatus applying NFT technology, the apparatus including an NFT tokenization unit configured to NFT-tokenize a gift certificate code stored in a gift certificate storage unit; a buying signal receiving unit configured to receive a buying signal of a gift certificate from a gift certificate buyer terminal; an NFT update unit configured to update an NFT-tokenized gift certificate code corresponding to the received buying signal; a gift certificate access address transmission unit configured to transmit an access address of the NFT-tokenized gift certificate code corresponding to the received buying signal to a gift certificate receiving terminal; and an NFT wallet unit configured to receive a closure request to close the access address of the gift certificate code from the gift certificate receiving terminal when the gift certificate receiving terminal rejects receiving the gift certificate, in which the NFT update unit is configured to restore the updated NFT-tokenized gift certificate code, in response to receiving the closure request.

According to one embodiment of the present invention, when the gift certificate receiving terminal accepts reception of the gift certificate, the gift certificate receiving terminal may connect to the access address and use the gift certificate, and when the gift certificate receiving terminal rejects receiving the gift certificate, a gift certificate buyer of the gift certificate buyer terminal may be registered in a blacklist.

In addition, a gift certificate of a new condition may be generated by dividing and recombining NFT tokens of different gift certificate codes stored in the gift certificate storage unit.

According to another embodiment of the present invention, a future amount of generation of gift certificate balances may be predicted using data of a past amount of generation of gift certificate balances stored in the gift certificate storage unit, and a discount rate of a mobile gift certificate may be presented based on the predicted future amount of generation of gift certificate balances In order to achieve another object described above, an exemplary embodiment of the present invention provides a computer-readable recording medium on which a program for executing the mobile gift certificate transaction method applying NFT technology on a computer.

According to the present invention, by enabling the gift certificate recipient to receive the access address of the NFT-tokenized gift certificate code, a gift certificate recipient can easily reject receiving the gift certificate transmitted from a gift certificate buyer.

In addition, according to the present invention, the gift certificate is NFT-tokenized, so that a gift certificate under a new condition can be generated by dividing and recombining NFT tokens of different gift certificate codes.

Furthermore, according to the present invention, it is possible to predict the future amount of generation of gift certificate balances by using the data of the past amount of generation of gift certificate balances, and to present a discount rate of the mobile gift certificate.

### BRIEF DESCRIPTION OF THE DRAWINGS

FIG. 1 is a configuration view of a mobile gift certificate brokerage apparatus applying NFT technology, according to one preferred embodiment of the present invention.

FIG. 2 shows an artificial neural network structure for extracting a future amount of generation of gift certificate balances required to present a transactable discount rate, based on a past amount of generation of gift certificate balances registered in the mobile gift certificate brokerage apparatus 200 applying NFT technology, according to the present embodiment.

FIG. 3 is a flowchart of a method of registering a gift certificate buying terminal in the mobile gift certificate brokerage apparatus applying NFT technology, according to one preferred embodiment of the present invention.

FIG. 4 is a flowchart of a login method through a gift certificate buying terminal to the mobile gift certificate brokerage apparatus applying NFT technology, according to one preferred embodiment of the present invention.

FIG. 5 is a flowchart of a mobile gift certificate transaction method applying NFT technology, according to one preferred embodiment of the present invention.

### DETAILED DESCRIPTION

Hereinafter, the present invention will be described in more detail with reference to preferred embodiments. However, the embodiments are to describe in more detail the present invention, and it will be apparent to one skilled in the art that the scope of the present invention is not limited thereto.

Configurations of the present invention to elucidate solutions for the problems to be solved by the present invention will be described in detail with reference to the accompanying drawings, based on the preferred embodiments of the present invention. In attaching reference numerals to components of the drawings, the same components are denoted by the same reference numerals even though the components are present in other drawings, and in describing the drawings, it will be appreciated that components of other drawings may be cited if necessary. Further, in describing in detail an operation principle of preferred embodiments of the present invention, when a detailed description of well-known functions or components relating to the present invention and other matters may unnecessarily make unclear the gist of the present invention, the detailed description thereof will be omitted.

A mobile gift certificate brokerage apparatus applying NFT technology according to one embodiment of the present invention can be used as a platform for brokering mobile gift certificate reselling transaction, and can strengthen authentication of users who buy gift certificates, and prevent reception of unwanted gift certificates.

Mobile gift certificates that are transacted in the mobile gift certificate brokerage apparatus according to one embodiment of the present invention are products for transacting gift certificates issued and sold by other companies or other systems to third parties, and can be transacted even when the mobile gift certificates are not issued on the mobile gift certificate brokerage apparatus.

On the other hand, regarding the mobile gift certificates that are transacted on the mobile gift certificate brokerage apparatus according to one embodiment of the present invention, a following abnormal situation may occur.

For example, a gift certificate recipient transfers a buying price to a gift certificate buyer to buy a mobile gift certificate from the gift certificate buyer, and receives the mobile gift certificate. However, if some of an amount of the mobile gift certificate was used, it is not possible to confirm by whom and when the amount of the mobile gift certificate was used.

Hereinafter, a configuration for preventing the abnormal situation will be described in detail.

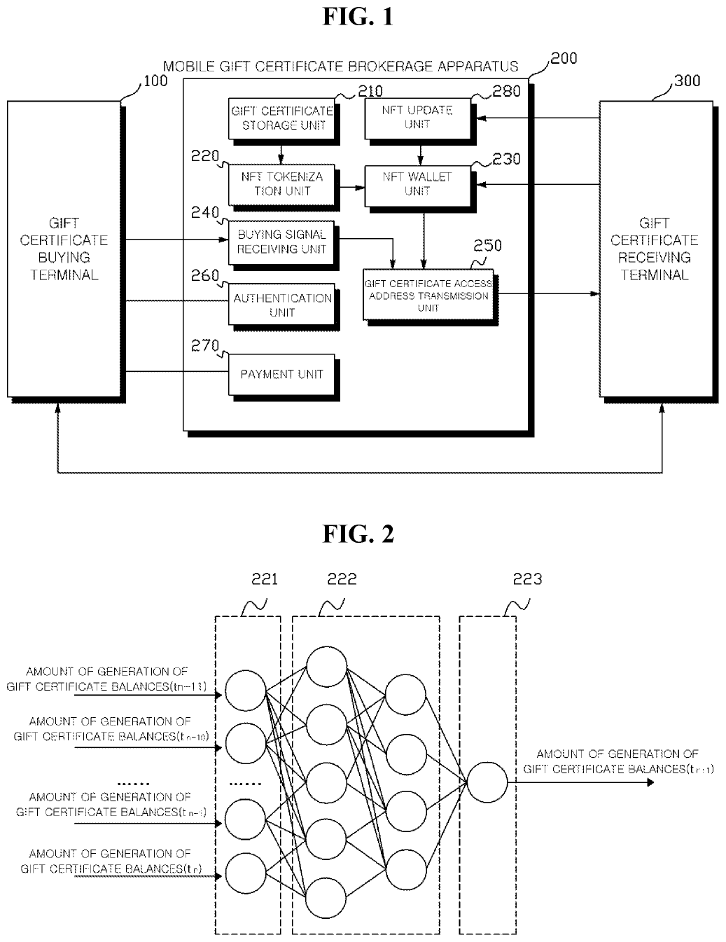

FIG. 1 is a configuration view of a mobile gift certificate brokerage apparatus applying NFT technology, according to one preferred embodiment of the present invention.

Referring to FIG. 1, the mobile gift certificate brokerage apparatus 200 applying NFT technology according to the present embodiment is preferably configured to perform a function of brokering a gift certificate buying terminal 100 and a gift certificate receiving terminal 300.

In particular, the mobile gift certificate brokerage apparatus 200 may be configured to perform NFT tokenization so as to easily perform a function of brokering different types of gift certificates issued by different gift certificate issuing companies between a gift certificate buyer and a gift certificate recipient.

The mobile gift certificate brokerage apparatus 200 applying NFT technology according to the present embodiment includes a gift certificate storage unit 210, an NFT tokenization unit 220, an NFT wallet unit 230, a buying signal receiving unit 240, a gift certificate access address transmission unit 250, an authentication unit 260, a payment unit 270, and an NFT update unit 280.

The gift certificate buying terminal 100 and the gift certificate receiving terminal 300 are terminals that are used by a gift certificate buyer and a gift certificate recipient, respectively, and may include electronic devices such as smartphones, desktop computers, laptops, digital broadcasting terminals, personal digital assistants (PDAs), portable multimedia players (PMPs), and tablet PCs. The electronic device may include one or more general or special purpose processors, a memory, a storage, and/or a (wired or wireless) networking component.

The gift certificate buying terminal 100 may buy a gift certificate posted on the mobile gift certificate brokerage apparatus 200 according to one embodiment of the present invention, or may buy a gift certificate on a separate gift certificate brokerage platform. When the gift certificate buying terminal buys a gift certificate on a separate gift certificate brokerage platform, the gift certificate buying terminal may take a photo including a gift certificate code and transmit the same to the mobile gift certificate brokerage apparatus 200 according to one embodiment of the present invention. The gift certificate code includes a QR code, a barcode or the like included in the photo of a paper gift certificate taken with a camera.

In a case in which the paper gift certificate has a predetermined form, the form may be detected through image analysis, an area with the gift certificate code may be deleted based on location, and the picture of the paper gift certificate may be posted on the mobile gift certificate brokerage apparatus 200.

The gift certificate code may include a store where the gift certificate can be used, a date of issuance of the gift certificate, an initial issuance amount, a balance of the gift certificate, a discount rate, and the like. The discount rate is preferably presented to the gift certificate buyer by calculating an optimal discount rate according to a transaction time in the mobile gift certificate brokerage apparatus 200.

The mobile gift certificate brokerage apparatus 200 is configured to be able to receive a gift certificate buying signal from the gift certificate buying terminal 100, and to transmit, to the gift certificate receiving terminal 300, a gift certificate access address with which the NFT-tokenized gift certificate code stored in the NFT wallet unit 230 can be accessed.

The mobile gift certificate brokerage apparatus 200 may be a server, or may be implemented in an application form that is installed in the gift certificate buying terminal 100 and the gift certificate receiving terminal 300. The mobile gift certificate brokerage apparatus 200 is preferably configured to NFT-tokenize a gift certificate or gift certificate code corresponding to the buying signal received from the gift certificate buying terminal 100 so that history information that the gift certificate receiving terminal 300 uses the NFT-tokenized gift certificate code is stored in a blockchain.

The gift certificate storage unit 210 is configured to store a gift certificate code of a gift certificate that is posted and sold on the mobile gift certificate brokerage apparatus 200. The stored gift certificate code may be a gift certificate issued on the mobile gift certificate brokerage apparatus 200 or a gift certificate issued on another gift certificate issuing platform. When the gift certificate code is issued on another gift certificate issuing platform, a store where the gift certificate can be used, a date of issuance of the gift certificate, an initial issuance amount, a balance of the gift certificate, a discount rate, and the like may be extracted and stored from a captured gift certificate photo.

The NFT tokenization unit 220 is configured to NFT-tokenize the gift certificate code stored in the gift certificate storage unit 210. NFT is a non-fungible token, and is a unique data unit stored by blockchain technology. In addition, NFT may be a digital asset in which unique values are assigned to an ownership of a gift certificate seller and transaction history.

When a gift certificate code is NFT-tokenized, the transaction details of the gift certificate can be disclosed transparently, and an amount of the gift certificate can be divided into 1/N and transacted.

In addition, it is possible to generate gift certificates of various conditions by dividing and recombining NFT tokens of gift certificates for which stores where the gift certificates can be used, dates of issuance of the gift certificates, initial issuance amounts, balances of the gift certificates, discount rates, and the like are different.

For example, if a gift certificate with a balance of 100,000 Won and a discount rate of 10% is recombined with a gift certificate with a balance of 100,000 Won and a discount rate of 5%, a gift certificate with a balance of 200,000 Won and a discount rate of 8% can be generated, and two gift certificates with a balance of 100,000 Won and a discount rate of 8% can also be generated. Therefore, by making the gift certificate code NFT-tokenized and transactable, it is possible to generate gift certificates of various conditions.

When NFT-tokenizing and transacting a gift certificate, blockchain technology is used to avoid loss or theft, and to make re-transaction easy because it is not dependent on the platform. Further, for existing mobile gift certificates, it is not possible to confirm whether a coupon has been used, during re-transaction, and there is a risk of barcode theft after reselling transaction. However, when a gift certificate is NFT-tokenized, the gift certificate is registered after confirming the gift certificate, and only an NFT owner can confirm the mobile gift certificate code. Therefore, a user can easily find and manage a mobile gift certificate through an NFT wallet.

The NFT wallet unit 230 is an electronic wallet configured to store NFT-tokenized gift certificate codes. Preferably, the electronic wallet is generated for each buyer of the gift certificate buying terminal 100. The NFT-tokenized gift certificate code stored in the NFT wallet unit 230 may have a gift certificate balance, a discount rate and the like changed by the NFT update unit 280.

The buying signal receiving unit 240 is configured to receive a signal for buying a mobile gift certificate from the gift certificate buying terminal 100. In a case of brokering a gift certificate bought on a separate online/offline gift certificate buying platform by the gift certificate buying terminal 100 through the mobile gift certificate brokerage apparatus 200, preferably, a gift certificate scan photo is received, and a gift certificate code is extracted, which is in turn stored in the NFT wallet unit 230 via the gift certificate storage unit 210 and the NFT tokenization unit 220.

The gift certificate access address transmission unit 250 is configured to transmit an access address such as a URL for accessing an NFT wallet corresponding to the gift certificate for which the buying signal is received by the buying signal receiving unit 240 to the gift certificate receiving terminal 300. Any address configured by information on a series of characters or numbers that can access the NFT wallet will be able to be transmitted to the gift certificate receiving terminal 300.

When the gift certificate access address that can access the NFT-tokenized gift certificate code is transmitted to the gift certificate receiving terminal 300, the gift certificate receiving terminal 300 can connect to the NFT wallet unit 230 to use the gift certificate or to move the NFT-tokenized gift certificate code stored in the NFT electronic wallet to a separate personal NFT electronic wallet.

When the buying signal is received from the gift certificate buying terminal 100, the authentication unit 260 and the payment unit 270 are configured to authenticate a buyer of the gift certificate buying terminal and then to proceed with payment.

The NFT update unit 280 may be configured to update NFT by reflecting information, which is changed as the NFT-tokenized gift certificate code stored in the NFT wallet unit 230 is sold, used, or the like, in the gift certificate information stored as NFT. For example, when an owner of a gift certificate is changed as the gift certificate is sold, the NFT update unit may update NFT by reflecting information, which indicates that the owner of the gift certificate has changed, in the gift certificate code.

The gift certificate buyer can complete the transfer of ownership of the gift certificate by receiving the NFT for the bought gift certificate from the gift certificate receiving terminal 300. In the meantime, when the gift certificate buyer completes the transfer of ownership of the gift certificate, the gift certificate information posted on the mobile gift certificate brokerage apparatus 200 is preferably blinded automatically.

FIG. 2 shows an artificial neural network structure for extracting a future amount of generation of gift certificate balances required to present a transactable discount rate, based on a past amount of generation of gift certificate balances registered in the mobile gift certificate brokerage apparatus 200 applying NFT technology, according to the present embodiment.

In order to set parameters of the artificial neural network shown in FIG. 2, an activation function, a learning rate, the number of times of learning, the number of neurons, an initial weight, and the like are used.

Referring to FIG. 2, an amount of generation (tₙ₊₁) of gift certificate balances for a next month can be predicted using data of amounts of generation (tₙ₊₁˜tₙ) of gift certificate balances for the past 12 months. A discount rate of the mobile gift certificate is preferably presented based on the predicted amount of generation (tₙ₊₁) of the gift certificate balances for the next month.

When the data of the amounts of generation (tₙ₊₁˜tₙ) of gift certificate balances for the past 12 months is input to an input neuron 221, training and verification are performed through a hidden neuron 222, and a structure with the smallest error between predicted data and actual value data is selected as a final structure. An output neuron 223 finally outputs the amount of generation (tₙ₊₁) of the gift certificate balances for the next month.

In general, in the case of gift certificates, an amount of generation of gift certificate balances decreases in months that include holidays such as Christmas, Thanksgiving Day and Children's Day, so that the discount rate is expected to be lower, and when there is no holiday in a month following the month that includes holidays, the discount rate is expected to be higher.

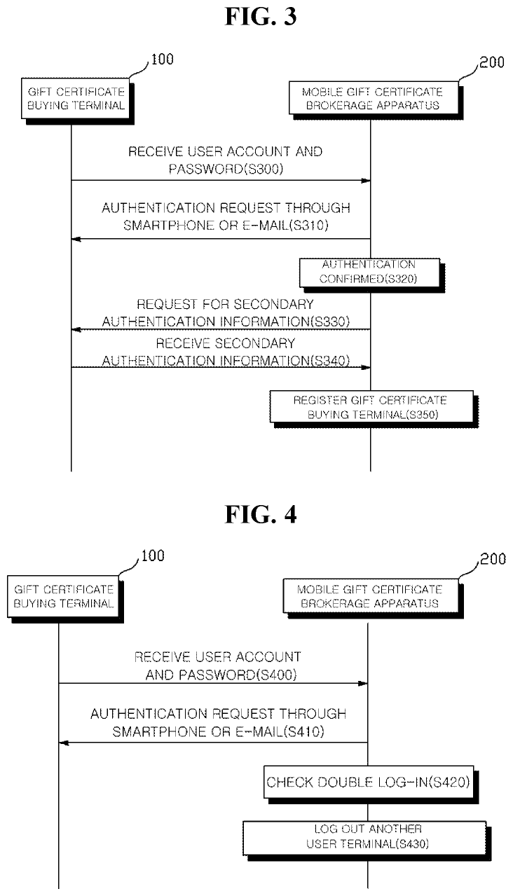

FIG. 3 is a flowchart of a method of registering a gift certificate buying terminal in the mobile gift certificate brokerage apparatus applying NFT technology, according to one preferred embodiment of the present invention.

In step 300, the mobile gift certificate brokerage apparatus 200 receives and registers a user account and a password from the gift certificate buying terminal 100.

In step 310, the mobile gift certificate brokerage apparatus 200 requests user authentication by using a smartphone number or e-mail address input from the gift certificate buying terminal 100.

Thereafter, user authentication may be performed by transmitting an authentication number received through a social network service (SNS) or short message service (SMS) installed in the gift certificate buying terminal to the mobile gift certificate brokerage apparatus. Alternatively, an authentication number may be transmitted to the e-mail address, and then the user may perform user authentication by transmitting the authentication number received through the e-mail address to the mobile gift certificate brokerage apparatus.

In step 320, when the user of the gift certificate buying terminal 100 inputs the authentication number, the mobile gift certificate brokerage apparatus 200 authenticates that the user is a legitimate user who uses the smartphone or the e-mail address.

In the meantime, since the user account and password received in step 300 and the smartphone number or e-mail address are used by the same user, it is preferable to store the same in association with each other.

In step 330, the mobile gift certificate brokerage apparatus 200 requests secondary authentication information from the gift certificate buying terminal 100. The secondary authentication information is preferably biometric information such as user's fingerprint, face and iris. The reason for requesting the secondary authentication information is that even if leakage of the user account and password, leakage of the authentication number due to smartphone loss, or leakage of the authentication number due to e-mail hacking occurs, the secondary authentication information strengthens security because it is personal inherent information.

In step 340, the mobile gift certificate brokerage apparatus 200 receives the secondary authentication information. The received secondary authentication information is preferably stored in association with the user account, the password and the smartphone number or e-mail address.

In step 350, the mobile gift certificate brokerage apparatus 200 registers the gift certificate buying terminal 100 as an authenticated terminal. It would be preferable to register the gift certificate buying terminal 100 as an authenticated terminal, and to enable only the registered terminal to perform the buying on the mobile gift certificate brokering apparatus 200.

FIG. 4 is a flowchart of a login method through a gift certificate buying terminal to the mobile gift certificate brokerage apparatus applying NFT technology, according to one preferred embodiment of the present invention.

In step 400, the mobile gift certificate brokerage apparatus 200 receives a user account and a password from the gift certificate buying terminal 100.

In step 410, the mobile gift certificate brokerage apparatus 200 requests authentication from a smartphone or e-mail address corresponding to the received user account.

In step 420, the mobile gift certificate brokerage apparatus 200 checks whether there is a gift certificate buying terminal logged in with the user account.

In step 430, as a result of checking by the mobile gift certificate brokerage apparatus 200, when there is another gift certificate buying terminal logged in with the user account, the corresponding gift certificate buying terminal is logged out to prevent double log-in.

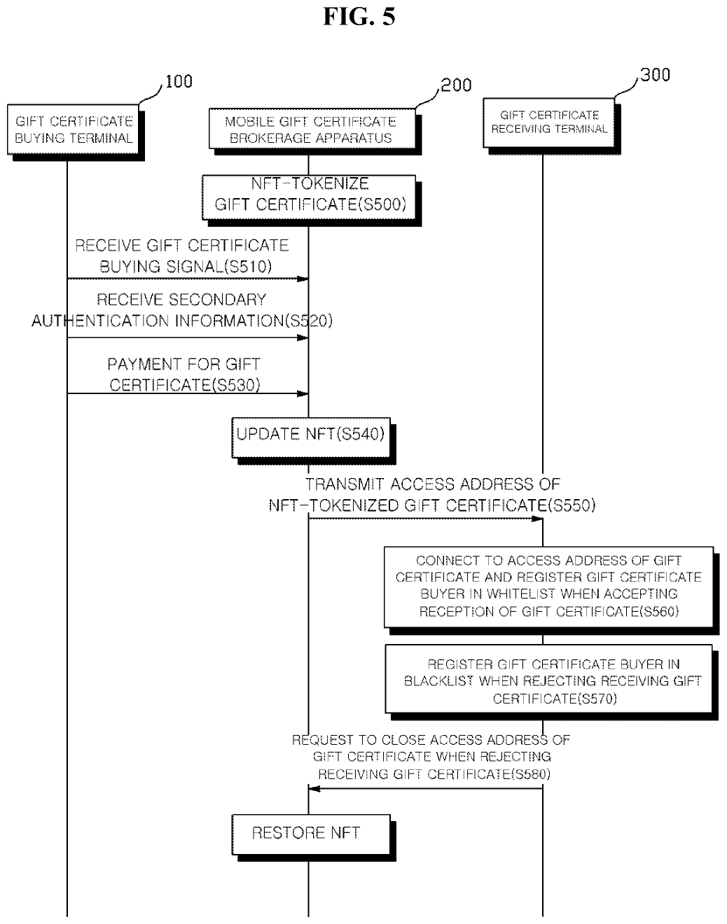

FIG. 5 is a flowchart of a mobile gift certificate transaction method applying NFT technology, according to one preferred embodiment of the present invention.

Referring to FIG. 5, the mobile gift certificate transaction method applying NFT technology, according to the present embodiment, includes steps that are processed in time-series on the mobile gift certificate brokerage apparatus shown in FIG. 1. Therefore, even if the content is omitted below, the contents described above with respect to the mobile gift certificate brokerage apparatus shown in FIG. 1 are also applied to the mobile gift certificate transaction method according to the present embodiment.

In step 500, the mobile gift certificate brokerage apparatus 200 NFT-tokenizes the gift certificate code stored in the gift certificate storage unit 210.

Meanwhile, separately from this, the mobile gift certificate brokerage apparatus 200 posts a gift certificate corresponding to the gift certificate code stored in the gift certificate storage unit 210 so that the gift certificate buyer can select and buy the gift certificate through the gift certificate buying terminal 100.

The gift certificate posted on the mobile gift certificate brokerage apparatus 200 may be newly generated and posted to have an amount and a discount rate desired by a gift certificate buyer by recombining the gift certificate code stored in the gift certificate storage unit 210.

In step 510, the mobile gift certificate brokerage apparatus 200 receives a signal for buying a mobile gift certificate from the gift certificate buying terminal 100. That is, the gift certificate buyer selects one of the gift certificates posted on the mobile gift certificate brokerage apparatus 200 through the gift certificate buying terminal 100 and transmits a buying signal to the mobile gift certificate brokerage apparatus 200.

In step 520, the mobile gift certificate brokerage apparatus 200 receives secondary authentication information of the gift certificate buyer before selling the gift certificate through the gift certificate buying terminal 100. Although not shown in FIG. 5, as shown in FIG. 4, it is preferable that the gift certificate buyer is logged in through an input of a user account and a password, or through smartphone or e-mail authentication.

In step 530, the mobile gift certificate brokerage apparatus 200 receives payment for the gift certificate selected in step 510 through the gift certificate buying terminal 100.

In step 540, the mobile gift certificate brokerage apparatus 200 updates NFT by reflecting the information, which is changed as the gift certificate is bought, in the gift certificate information stored in the NFT.

In step 550, the mobile gift certificate brokerage apparatus 200 transmits an access address of the NFT-tokenized gift certificate to the gift certificate receiving terminal 300.

In step 560, when accepting reception of the gift certificate, the gift certificate receiving terminal 300 may connect to the access address of the NFT-tokenized gift certificate received in step 550, and register the gift certificate buyer who bought the gift certificate in a whitelist.

The access address of the NFT-tokenized gift certificate transmitted from the gift certificate buyer registered in the whitelist can be accessed without separate acceptance of reception of a gift certificate.

In step 570, when rejecting receiving the gift certificate, the gift certificate receiving terminal 300 requests the mobile gift certificate brokerage apparatus 200 to close the access address of the NFT-tokenized gift certificate received in step 550.

In step 580, when the mobile gift certificate brokerage apparatus receives the request to close the access address of the NFT-tokenized gift certificate in step 570, the mobile gift certificate brokerage apparatus restores the NFT updated in step 540 to a previous state.

The term ‘-unit’ used in the present embodiment means software or a hardware component such as a field-programmable gate array (FPGA) or ASIC, and the ‘˜unit’ performs certain roles. However, the ‘˜unit’ is not limited to software or hardware. The ‘˜unit’ may be configured to be located on an addressable storage medium, or may be configured to reproduce one or more processors. Therefore, as an example, the ‘˜unit’ includes components such as software components, object-oriented software components, class components, and task components, processes, functions, attributes, procedures, subroutines, segments of program codes, drivers, firmware, microcodes, circuits, data, databases, data structures, tables, arrays, and variables. Components and functions provided in the ‘˜units’ can be combined into a smaller number of components and ‘˜units’, or can be further divided into additional components and ‘˜units’. In addition, components and ‘˜units’ may be implemented to reproduce one or more CPUs in a device or a security multimedia card.

All functions described above may be performed by a processor such as a microprocessor, a controller, a microcontroller, and an application specific integrated circuit (ASIC) according to software, a program code or the like coded to perform the functions described above. The code may be designed, developed, and implemented on the basis of the descriptions of the present invention, which are well known to one skilled in the art.

Although the present invention has been described with reference to the embodiments, it will be understood by one skilled in the art that various modifications and variations can be made in the present invention without departing from the technical spirit and scope of the present invention. Therefore, it is intended that the present invention is not limited to the above embodiments and embraces all embodiments within the scope of the claims.

What is claimed is:

1. A mobile gift certificate transaction method applying NFT technology, the method comprising:
NFT-tokenizing a gift certificate code stored in a gift certificate storage unit;
receiving a buying signal of a gift certificate from a gift certificate buyer terminal;
updating an NFT-tokenized gift certificate code corresponding to the received buying signal;
transmitting an access address of the NFT-tokenized gift certificate code corresponding to the received buying signal to a gift certificate receiving terminal;
receiving a closure request to close the access address of the gift certificate code from the gift certificate receiving terminal when the gift certificate receiving terminal rejects receiving the gift certificate; and
restoring the updated NFT-tokenized gift certificate code, in response to receiving the closure request.

2. The mobile gift certificate transaction method according to claim 1, wherein
when the gift certificate receiving terminal accepts reception of the gift certificate, the gift certificate receiving terminal connects to the access address and uses the gift certificate, and
when the gift certificate receiving terminal rejects receiving the gift certificate, a gift certificate buyer of the gift certificate buyer terminal is registered in a blacklist.

3. The mobile gift certificate transaction method according to claim 1, wherein
a gift certificate under a new condition is generated by dividing and recombining NFT tokens of different gift certificate codes stored in the gift certificate storage unit.

4. The mobile gift certificate transaction method according to claim 1, wherein
a future amount of generation of gift certificate balances is predicted using data of a past amount of generation of gift certificate balances stored in the gift certificate storage unit, and a discount rate of a mobile gift certificate is presented based on the predicted future amount of generation of gift certificate balances.

5. A mobile gift certificate transaction apparatus applying NFT technology, the apparatus comprising:
an NFT tokenization unit configured to NFT-tokenize a gift certificate code stored in a gift certificate storage unit;
a buying signal receiving unit configured to receive a buying signal of a gift certificate from a gift certificate buyer terminal;
an NFT update unit configured to update an NFT-tokenized gift certificate code corresponding to the received buying signal;
a gift certificate access address transmission unit configured to transmit an access address of the NFT-tokenized gift certificate code corresponding to the received buying signal to a gift certificate receiving terminal; and
an NFT wallet unit configured to receive a closure request to close the access address of the gift certificate code from the gift certificate receiving terminal when the gift certificate receiving terminal rejects receiving the gift certificate,
wherein the NFT update unit is configured to restore the updated NFT-tokenized gift certificate code, in response to receiving the closure request.

6. The mobile gift certificate transaction apparatus according to claim 5, wherein when the gift certificate receiving terminal accepts reception of the gift certificate, the gift certificate receiving terminal connects to the access address and uses the gift certificate, and when the gift certificate receiving terminal rejects receiving the gift certificate, a gift certificate buyer of the gift certificate buyer terminal is registered in a blacklist.

7. The mobile gift certificate transaction apparatus according to claim 5, wherein a gift certificate under a new condition is generated by dividing and recombining NFT tokens of different gift certificate codes stored in the gift certificate storage unit.

8. The mobile gift certificate transaction apparatus according to claim 5, wherein a future amount of generation of gift certificate balances is predicted using data of a past amount of generation of gift certificate balances stored in the gift certificate storage unit, and a discount rate of a mobile gift certificate is presented based on the predicted future amount of generation of gift certificate balances.

9. A computer-readable recording medium on which a program for executing the method according to claim 1 on a computer is recorded.
